(19) United States
(12) Patent Application Publication
(10) Pub. No.: US 2015/0172738 A1
(43) Pub. Date: Jun. 18, 2015

(54) REPRODUCTION DEVICE, REPRODUCTION METHOD, AND RECORDING MEDIUM

(71) Applicants: Reiko Mitsuhashi, Osaka-shi (JP); Umihiko Suzuki, Osaka-shi (JP)

(72) Inventors: Reiko Mitsuhashi, Osaka-shi (JP); Umihiko Suzuki, Osaka-shi (JP)

(73) Assignee: SHARP KABUSHIKI KAISHA, Osaka-shi, Osaka (JP)

(21) Appl. No.: 14/360,380

(22) PCT Filed: Aug. 20, 2012
(86) PCT No.: PCT/JP2012/071010

§ 371 Date: May 23, 2014

(30) Foreign Application Priority Data
Nov. 24, 2011 (JP) 2011-256688

(51) Int. Cl. H04N 21/262; H04N 21/2387; H04N 5/783; H04N 21/472; H04N 21/845

(52) U.S. Cl. CPC H04N 21/26283; H04N 21/26291; H04N 21/47217; H04N 21/8456; H04N 5/783; H04N 21/2387

(57) ABSTRACT

A client apparatus includes: a replay control section for, at the time of a replay control operation, making a decision as to whether or not to prohibit the replay control, the decision being based on a period that is specified by MPD and that is acquirable at the current point in time; and a notification section for, in a case where the replay control section has decided to prohibit the replay control, notifying the user accordingly.

### TECHNICAL FIELD

The present invention relates to a replay apparatus that replays content that is distributed by time division and, more particularly, to replay control of content in such a replay apparatus.

### BACKGROUND ART

In recent years, the distribution of video content through communication networks has been well-practiced. In the light of such circumstances, various technologies for the streaming distribution of video content have been under development. An example of the technologies is DASH (Dynamic Adaptive Streaming over HTTP), which is currently being standardized in conformity to MPEG (Moving Picture Experts Group).

DASH specifies two formats, namely MPD (Media Presentation Description) and a media segment. A media segment is a transmission unit of of HTTP transmission into which video content has been time-divided. Further, MPD is control metadata for streaming distribution, and also contains, for example, information indicating whether the video content is content that is distributed live (live distributed content) or VOD content.

A client apparatus acquires MPD from a distribution server before receiving the distribution of video content and, on the basis of the respective URLs of media segments described in the MPD, acquires the media segments in sequence, thereby replaying the video content. Further, a DASH-compatible client apparatus can perform trick plays such as time-shifting and fast-forward since the MPD contains information on all media segments that are acquirable.

Incidentally, some live content, such as a replay broadcast of a baseball game or a news program as in the case of a disaster having struck, does not have a fixed distribution stop time even after the distribution has started. In the case of distribution of such live content, it is not until the distribution stop time is fixed that the distribution server can generate MPD containing the URLs of all media segments that are to be eventually distributed and transmit the MPD to a client apparatus.

For this reason, the distribution server performs a process, called “MPD Update”, of providing the client apparatus with regular updates to the MPD during the distribution of the content so that the client apparatus can replay the live content to the end. This allows even such live content to be replayed to the end. However, the range of media segments on which the client apparatus can perform trick plays is confined to those media segments whose URLs are described in the MPD.

Further, such a content distribution system etc. are becoming a reality that a replay timing is assigned to each media segment or to a period (interval of content replay) consisting of a plurality of media segments and a replay is prohibited until the timing comes.

Providing such a replay timing allows handling of content, such as live content, whose media segments cannot be acquired until the respective timings come. That is, setting a replay timing makes it possible to prevent a request for a media segment whose distribution cannot be received (whose distribution time is yet to come).

Further, in the case of content containing a main video and a promotional video inserted in the main video, a user's operation of fast-forwarding the promotional video can be prevented by preventing a replay of subsequent media segments until the stop time of the promotional video. This makes it possible to, while allowing the user to view the main video, force the user to view the promotional video as the distributor intended.

In the case of such content distribution, such specifications are conceivable, for example, that: while fast-forward is prohibited during a live replay of live distributed content, fast-rewind is permitted; and after fast-rewind, fast-forward up to the point where the content has already been replayed is permitted. That is, it is conceivable to prohibit replay control in accordance with a timing at which a replay control operation was performed and a media segment or period that is acquirable at that time.

However, since prohibition of replay control of of such time-division distributed content is determined in accordance with a media segment or period that is acquirable at that time, it is difficult for the user to recognize why the replay control operation that he/she has performed was not accepted. This is because the user cannot perceive a media segment or period that is acquirable at that time.

Therefore, since replay control according to the operation is not executed, the user may be misled or confused into thinking that the replay apparatus has failed.

It should be noted here that Patent Literature 1 discloses a conventional technology for notifying a user that a replay control operation that is prohibited has been performed. Patent Literature 1 also discloses notifying a user, during a chase playback of content being recorded, that a fast-forward replay cannot be performed, if the currently replayed part is in a fast-forward warning area.

### CITATION LIST

Patent Literature 1

Japanese Patent Application Publication, Tokukai, No. 2004-72431 (Publication Date: Mar. 4, 2004)

### SUMMARY OF INVENTION

### Technical Problem

However, the object to be replayed by the technology of Patent Literature 1 is content being recorded, and is totally different in nature from such content that is distributed by time division. Therefore, it is difficult to apply the technology of Patent Literature 1 to content that is distributed by time division.

That is, in the case of content being recorded, it is possible that on the basis of a period of time having elapsed since completion of the recording of each constituent part constituting the content, a constituent part falling within a given period of time from completion of the recording can be determined as a fast-forward warning area.

Meanwhile, in the case of content that is distributed by time division, streaming distribution is usual, and in the case of streaming distribution, recording is impossible. Further, even in a case where recording is possible, a constituent part being recorded and a part that is acquirable do not necessarily coincide with each other. For example, in the case of common streaming distribution, it is conceivable to start a replay of live distributed content at a time later than the distribution start time. Moreover, in such a case, a constituent part being recorded and a part that is acquirable can be different from each other.

For this reason, an apparatus that replays content that is distributed by time division is not suitable to a process, such as that of Patent Literature 1, which is based on a period of time having elapsed since the end of recording. That is, in the case of an apparatus that replays content that is distributed by time division, it is desirable that a process suitable to the nature of content that is distributed by time division be performed so that the user is not misled or confused even in a case where replay control according to an operation is not executed.

The present invention has been made in view of the foregoing problems, and it is an object of the present invention to provide a replay apparatus etc. which, during a replay of content that is distributed by time division, does not get a user so misled or confused even in a case where replay control according to an operation is not executed.

### Solution to Problem

In order to attain the foregoing object, a replay apparatus of the present invention is a replay apparatus for, with reference to content acquisition information containing at least information for acquiring constituent parts of content that is distributed by time division, acquiring and replaying the content, the replay apparatus including: replay control means for, upon accepting a user's operation that gives a command to execute replay control of the content, making a decision as to whether or not to execute the replay control, the decision being based on which part of the content is a constituent part that is specified by the content acquisition information and that is acquirable at a point in time where the command was accepted; and notification means for, in a case where the replay control means has decided not to execute the replay control, notifying the user that the replay control is prohibited.

Further, a replay method of the present invention is a replay method by a replay apparatus for, with reference to content acquisition information containing at least information for acquiring constituent parts of content that is distributed by time division, acquiring and replaying the content, the replay method including: a replay control step of, upon accepting a user's operation that gives a command to execute replay control of the content, making a decision as to whether or not to execute the replay control, the decision being based on which part of the content is a constituent part that is specified by the content acquisition information and that is acquirable at a point in time where the command was accepted; and a notification step of, in a case where it has been decided in the replay control step that the replay control is not executed, notifying the user that the replay control is prohibited.

Upon accepting a command to execute replay control, the foregoing configuration makes a decision as to whether or not to execute the replay control, the decision being based on which part of the content is a constituent part that is specified by the content acquisition information and that is acquirable at a point in time where the command was accepted. For example, if the constituent part to which the replay position shifts in a case where the replay control is performed is not acquirable at that point in time, the foregoing configuration decides not to execute the replay control. Then, upon deciding not to execute, the foregoing configuration notifies the user that the replay control is prohibited.

Therefore, even in a case where the user has performed an operation that gives a command to execute replay control that is prohibited but the replay control corresponding to the operation is not performed, the foregoing configuration does not get the user misled or confused into thinking that the replay apparatus has failed.

### Advantageous Effects of Invention

As described above, a replay apparatus of the present invention includes: replay control means for, upon accepting a user's operation that gives a command to execute replay control of the content, making a decision as to whether or not to execute the replay control, the decision being based on which part of the content is a constituent part that is specified by the content acquisition information and that is acquirable at a point in time where the command was accepted; and notification means for, in a case where the replay control means has decided not to execute the replay control, notifying the user that the replay control is prohibited.

Further, as described above, a replay method of the present invention includes: a replay control step of, upon accepting a user's operation that gives a command to execute replay control of the content, making a decision as to whether or not to execute the replay control, the decision being based on which part of the content is a constituent part that is specified by the content acquisition information and that is acquirable at a point in time where the command was accepted; and a notification step of, in a case where it has been decided in the replay control step that the replay control is not executed, notifying the user that the replay control is prohibited.

This brings about such an effect of, even in a case where the user has performed an operation that gives a command to execute replay control that is prohibited but the replay control corresponding to the operation is not performed, prevent the user from getting misled or confused into thinking that the replay apparatus has failed.

### BRIEF DESCRIPTION OF DRAWINGS

FIG. 1 is a block diagram showing a configuration of main parts of a client apparatus and a distribution server, respectively, that constitute a distribution system according to a first embodiment of the present invention.

FIG. 2 is a diagram showing an overall configuration of the distribution system.

FIG. 3 is a diagram explaining an interval of replay during which the client apparatus prohibits a particular replay control.

FIG. 4 is a diagram explaining how the client apparatus decides, on the basis of MPD, whether or not to permit replay control.

FIG. 5 is a flow chart showing an example of a replay control operation handling process that the client apparatus executes when a fast-forward operation has been performed.

FIG. 6 is a flow chart showing an example of a replay control operation handling process that the client apparatus executes when a fast-rewind operation has been performed.

FIG. 7 is a diagram explaining a second embodiment that is different from the first embodiment, and is a diagram explaining an interval of replay during which a client apparatus prohibits a particular replay control.

FIG. 8 is a diagram explaining how, in the second embodiment, the client apparatus decides, on the basis of MPD, whether or not to permit replay control.

FIG. 9 is a flow chart showing an example of a replay control operation handling process that, in the second embodiment, the client apparatus executes when a fast-forward operation has been performed.

FIG. 10 is a flow chart showing an example of a replay control operation handling process that, in the second embodiment, the client apparatus executes when a fast-rewind operation has been performed.

### DESCRIPTION OF EMBODIMENTS

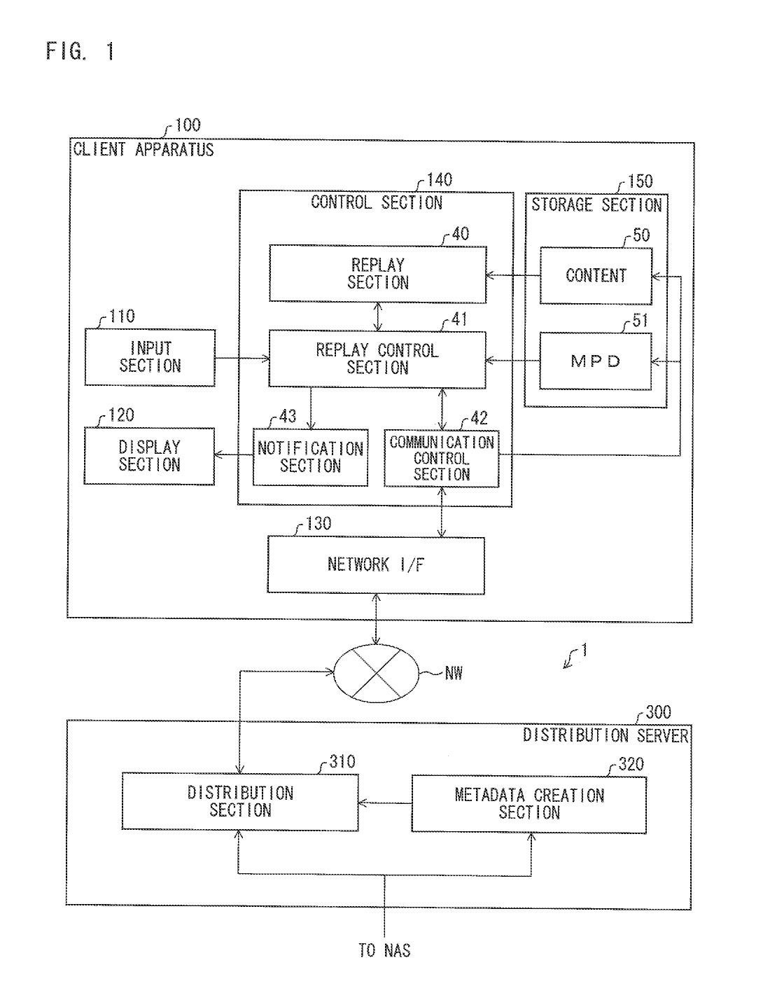

An embodiment of the present invention is described below with reference to FIGS. 1 through 6.

### Embodiment 1

A distribution system according to an embodiment of the present invention is a distribution system that is capable of live streaming distribution of time-divided content to a client apparatus. It should be noted that the system uses the aforementioned DASH-specified data formats for metadata and media segments. That is, the present embodiment is described by taking as an example a case where content is distributed in units of media segments by using MPD. However, the range of application of the present invention is not limited to this example, and the present invention is applicable to any client apparatus that acquires time-divided content by using content acquisition information containing information for acquiring each constituent part of the content.

[Overview of a Distribution System]

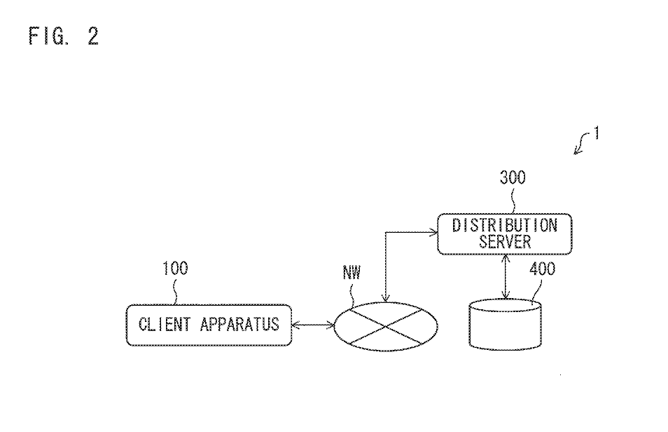

An overview of such a distribution system is described with reference to FIG. 2 first, and then a client apparatus and a distribution server that constitute the distribution system are described in detail with reference to FIG. 1. FIG. 2 is a diagram showing an overall configuration of a distribution system 1 according to the present embodiment, and FIG. 1 is a block diagram showing main parts of a client apparatus (replay apparatus) 100 and a distribution server 300 that constitute the distribution system 1.

As shown in FIG. 2, the distribution system 1 is a system that includes the client apparatus 100, the distribution server 300, and a network storage server (NAS) 400. Further, the client apparatus 100 and the distribution server 300 are connected to an NW (Internet). The distribution system 1 is a system in which the distribution server 300 distributes content stored in the NAS 400 to the client apparatus 100 through the NW.

[Client Apparatus 100]

As shown in FIG. 1, the client apparatus 100 includes an input section 110, a display section 120, a network I/F 130, a control section 140, and a storage section 150.

The client apparatus 100 receives from a user through the input section 100 a replay instruction to replay vide content. In the following, video content for which a replay instruction has been received is referred to also as “target video content”.

Moreover, the client apparatus 100 receives the target video content from the distribution server 300 in units of media segments (i.e. units obtained by dividing, at regular time intervals, data encoding the video content; hereinafter referred to also as “MSs”) from the distribution server 300 and replays the target video content.

Specifically, upon receiving the replay instruction, the client apparatus 100 receives, from the distribution server 300, MPD concerning the target video content, thereby specifying the URLs of MSs that are to be received for the target video content to be replayed. Then, at a distribution start time, the client apparatus 100 receives the MSs from the distribution server 300 designated by the URLs and starts to replay the target video content. Further, the client apparatus 100 acquires MPD from the distribution server 300 at regular time intervals even while replaying the target video content. Then, while replaying the target video content, the client apparatus 100 receives, on the basis of the most recent MPD acquired, MSs necessary for the target video content to continue to be replayed.

A main feature of the client apparatus 100 is that in replaying content that is distributed, the client apparatus 100 detects, on the basis of MPD, that a replay control operation that is prohibited has been performed, and notifies the user of the client apparatus 100 accordingly. The term “replay control” here means control that causes a replay position to shift in a form that is different from that in which it shifts in a normal replay. To take a specific example, control that causes fast-forward, fast-rewind, time-shifting, etc. to be performed corresponds to the replay control. It should also be noted that an user's operation for executing such control is called a replay control operation.

The input section 110 accepts an input operation that the user performs on the client apparatus 100, and transmits the input operation to the control section 140. The input section 110 needs only include these functions, and a specific configuration thereof needs only be compatible with the functions etc. of the client apparatus 100. For example, in a case where the client apparatus 100 is a television receiver, the input section 110 may be a set of operation buttons provided on the body of the apparatus. Alternatively, the input section 110 may be a signal receiving section that receives control signals from a remote controller. Alternatively, in a case where the client apparatus 100 is a smartphone or a tablet, the input section 110 may be a touch panel. Alternatively, the input section 110 may be an apparatus external to and separate from the client apparatus 100.

The display section 120 serves to display images, and the target video content is also displayed on the display section 120. Although an example is described here where the client apparatus 100 includes the display section 120, the display section 120 may be an apparatus external to and separate from the client apparatus 100.

The network I/F 130 is an interface via which the client apparatus 100 communicates with another apparatus. The client apparatus 100 exchanges data with the distribution server 300 via the network I/F 130.

The control section 140 serves to overall control how the client apparatus 100 operates, and includes a replay section 40, a replay control section (replay control means) 41, a communication control section 42, and a notification section (notification means) 43.

The replay section 40 reads out MSs buffered in the storage section 150, decodes them, and replays them, thereby displaying the target video content on the display section 120. It should be noted here that the MSs are read out in order of replay time.

The replay control section 41 performs replay control of content. Specifically, the replay control section 41 controls the replay section 40 and the communication control section to perform trick plays such as fast-forward and fast-rewind. Further, upon accepting a command to execute replay control, the replay control section 41 decides whether or not to execute the replay control. Furthermore, during the replay control, the replay control section 41 decides, in accordance with the replay position of that time, whether or not to discontinue the replay control.

The communication control section 42 controls communication that is performed via the network I/F 130. Specifically, the communication control section 42 buffers, in the storage section 150, the MSs received from the distribution server 300. Further, the communication control section 42 regularly acquires the most recent MPD from the distribution server 300. Furthermore, with reference to the MPD thus acquired, the communication control section 42 specifies the distribution start time of each MS constituting that part of the target video content which is to be replayed. Moreover, the communication control section 42 specifies the URL of the MS to be replayed, and transmits, to the distribution server 300, an HTTP request for receiving the MS.

The notification section 43 is a section which, when the replay control section 41 has decided not to execute the replay control as commanded, notifies the user that the replay control is prohibited. Specifically, the notification section 43 notifies the user by causing the display section 120 to show that the replay control is prohibited. For example, in a case where a fast-forward operation has been performed and the replay control section 41 has decided not to execute fast-forward replay control, the notification section 43 causes the display section 120 to show that fast-forward is prohibited.

The user needs only be notified such that the user can recognize that the replay control operation that the user has performed is currently prohibited, and this example does not imply any limitation. For example, the user may be notified by sound from a speaker or the like. In a case where the client apparatus 100 includes a light-emitting section such as an LED, the user may be notified by lighting or blinking of the light-emitting section. Alternatively, in a case where the client apparatus 100 is a portable electronic apparatus such as a smartphone and includes a vibratory device functioning as the so-called vibrator, the user may be notified by vibrations.

The storage section 150 is a section in which to store various types of data that are used by the client apparatus 100. Content 50 and MPD (content acquisition information) 51, too, are stored in the storage section 150. As mentioned above, the content 50 is target image content buffered in units of MSs constituting the target video content. Further, MPD corresponding to this content 50 is stored as the MPD 51.

[Distribution Server 300]

The distribution server 300 is a server that distributes content to the client apparatus 100, and includes a distribution section 31 and a metadata creation section 320. The distribution section 31 controls distribution of content and MPD, and the metadata creation section 320 creates MPD.

Upon receiving a MPD transmission request from the client apparatus 100, the distribution section 310 transmits, to the client apparatus 100, the most recent MPD of that time as recorded in the NAS 400. Then, upon receiving an MS transmission request from the client apparatus 100, the distribution section 310 distributes, to the client apparatus 100, the MS recorded in the NAS 400.

The metadata creation section 320 generates the MPD of target video content at predetermined time intervals in parallel with an encoding process in units of MSs constituting the target video content, and records the MSs in the NAS 400. It should be noted that the encoding process is performed by a live encoder (not illustrated), and the MSs thus encoded are recorded in the NAS 400.

[NAS 400]

The NAS 400 is a network storage (Network Attached Storage) that retains MSs constituting video content and MPD concerning video content. As mentioned above, MSs and MPD retained in the NAS are distributed by the distribution server 300 to the client apparatus 100.

[Interval of Replay During which Replay Control is Prohibited]

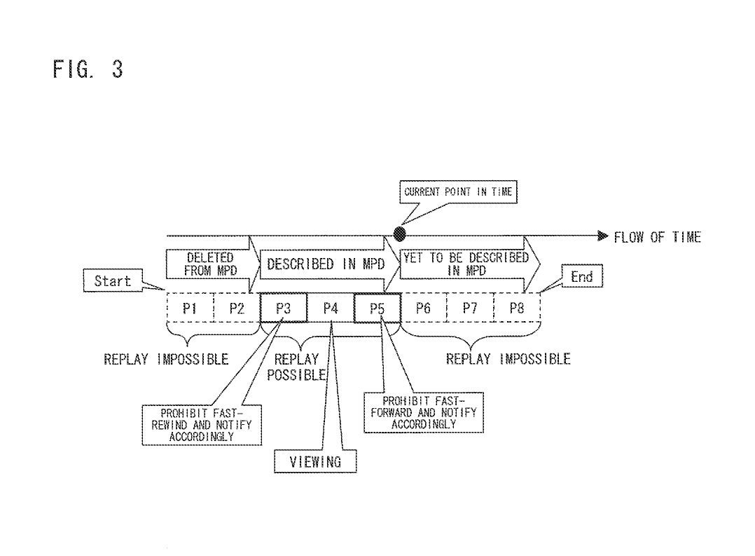

In the following, an interval of replay (hereinafter referred to also as “interval of prohibition”) during which a particular replay control is prohibited is described with reference to FIG. 3. FIG. 3 is a diagram explaining an interval of replay during which a particular replay control is prohibited. In the example shown in FIG. 3, the video content to be replayed consists of eight periods, namely periods P1 to P8.

Further, up to the period P5 has been described in the MPD at the current point in time, and are acquirable; however, the periods P1 and P2 have been deleted from the MPD. That is, in the most recent MPD acquired, the periods P3 to P5 are described. Moreover, the client apparatus 100 is replaying the period P4, which the user is viewing.

In this situation, the MPD acquired contains the periods P3 to P5. Therefore, in the interval of replay from the period P3 to the period P5, replay control is possible across the periods. That is, according to this MPD, since it is possible to acquire the period P5 subsequent to the currently replayed period P4, it is possible to shift to the period P5 by performing fast-forward from the current replay position. Further, it is also possible to fast-rewind to the period P4 after performing fast-forward up to the period P5. Moreover, in this interval of replay, it is similarly possible to perform a special replay such as a skip replay across the periods. The term “skip replay” here means a replay that makes a shift from the current replay position to a replay position that precedes or follows the current replay position by a predetermined period of time.

Meanwhile, the period 6 and its subsequent periods cannot be replayed, as they have not been described in the MPD acquired at the current point in time. For this reason, in this situation, it is impossible to perform a special replay such as making a shift to the interval of replay of the period P6 and its subsequent periods. Therefore, replay control that causes a trick play to be performed to make a shift to the interval of replay of the period P6 and its subsequent periods is invalid. The same is true for a trick play that makes a shift to the periods P1 and P2, which have been deleted from the MPD.

Since the period P5 here is acquirable, it is physically possible to perform fast-forward in the period P5. However, a permission to perform fast-forward in the period P5 may pose a risk of allowing the period P5 to be replayed to the end while the period P6 cannot be acquired. Such a case is not preferable, as the replay is discontinued.

In order to avoid this, in the client apparatus 100, fast-forward is prohibited in a situation where the next period cannot be acquired. For example, in the example illustrated, fast-forward replay control is prohibited in a case where the current replay position is in the period P5. That is, the period P5 is designated as an interval of prohibition of fast-forward replay control.

However, simply prohibiting fast-forward may pose a risk of getting the user confused because an action based on the operation is not carried out. In order to avoid this, when a fast-forward operation has been performed in an interval of prohibition of fast-forward replay control, the client apparatus 100 notifies the user that such a fast-forward operation is prohibited. This makes it possible to prevent such confusion in the user.

Further, for the same reason, fast-rewind is prohibited in the period P3, whose immediately preceding period cannot be acquired. That is, the period P3 is designated as an interval of prohibition of fast-rewind replay control. Moreover, when a fast-rewind operation has been performed in this interval of prohibition, the user is notified that fast-rewind is prohibited.

It should be noted that the designation of an interval of prohibition is not limited to the above example. For example, fast-forward up to a predetermined period of time before the finish time of the period P5 may be permitted in the period P5, whose subsequent periods cannot be acquired, and the subsequent periods may be designated as an interval of prohibition. That is, an interval of prohibition may be an interval shorter than a period, or may be a particular point in time (for example, a point in time at the tail end of the latest period acquired).

Alternatively, fast-rewind up to the head of the period P3, whose immediately preceding period cannot be acquired, may be permitted, and when fast-rewind has been performed at the head, the user may be notified that fast-rewind is prohibited. In this case, the head of the period P3 is designated as an interval of prohibition of fast-rewind.

Furthermore, it is possible not to prohibit physically possible replay control such as fast-rewind in the period P3 or fast-forward in the period P5, and to prohibit only physically impossible replay control such as a time-shifting replay that makes a shift to a period that cannot be replayed or to notify the user only of such physically impossible replay control.

In a case where a period preceding the current point in time that is referred to in the MPD is acquirable from a server different from the distribution server 300, whether or not to permit replay control can be decided with the period deemed to be acquirable. For example, in the example shown in FIG. 3, there may be a case where the period P2 has been deleted from the distribution server 300 but is stored in another server and information (such as a URI) for acquiring the period 2 from the server is described in the MPD. In such a case, fast-forward in the period P2 and fast-rewind in the period P3 may be permitted.

That is, regardless of whether the source from which a period is acquired is the distribution server 300 or another server, it is only necessary to decide, in accordance with whether the period is acquirable at that point in time, whether or not to permit replay control.

Thus, in DASH, acquirable periods can vary according to replay time. Further, even a period that cannot be acquired from the distribution server 300 may be able to be acquired from another server.

This makes it difficult for the user to know why the same replay control operation is accepted at one time but not at another time, depending on the timing at which the operation has been performed. This may get the user confused when control according to the operation that he/she had performed is not performed. Therefore, when replay control that is prohibited has been performed, it is highly necessary to notify the user accordingly.

In this regard, the client apparatus 100 is configured to, when replay control that is prohibited has been performed, notify the user accordingly. Further, since a decision as to whether or not to permit replay control is made on the basis of MPD, it is possible to simply and accurately decide whether or not to permit replay control, and an appropriate notification can be made.

[MPD-Based Decision as to Whether or Not to Permit Replay Control]

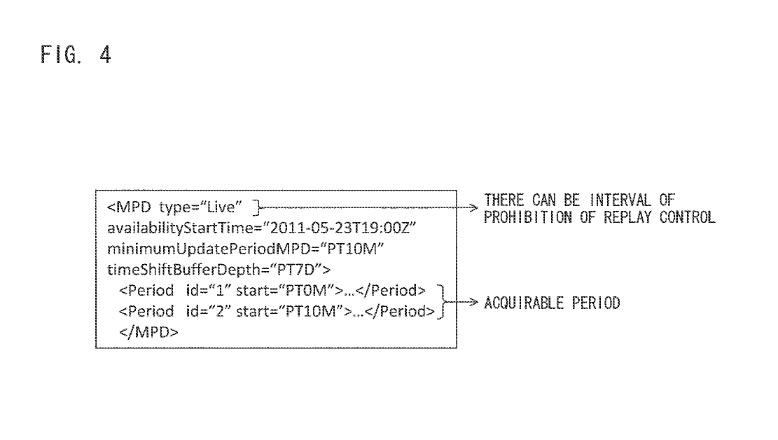

The replay control section 41 of the client apparatus 100 decides, with reference to the MPD 51 stored in the storage section 150, whether or not to permit replay control. This method of decision is described with reference to FIG. 4. FIG. 4 is a diagram showing how the client apparatus 100 decides, on the basis of the MPD 51, whether or not to permit replay control.

In the MPD 51 illustrated, the attribute value of the attribute “type” (content attribute information) is described as “Live”. The attribute value of “Live” indicates that the content is live distributed content. In the case of a replay of live distributed content, there can be an interval of prohibition of replay control. For this reason, in a case where “MPD type” is described as “Live”, the replay control section 41 decides whether or not to permit replay control.

Conversely, when the attribute value of “type” is a value other than “Live” (such as “Vod”: Video On Demand), the replay control section 41 does not make a decision as to whether or not to permit replay control. This is because a replay of content whose attribute value is “Vod” or the like can be controlled throughout the entire interval. However, even when the attribute value of “type” is a value other than “Live”, the decision may be made, provided the content is content in which a particular replay control is prohibited under a particular condition.

Further, in the MPD 51 illustrated, information regarding a period that is acquirable by the client apparatus 100. Specifically, for each period, an attribute “id” that specifies the period and an attribute “start” that indicates the start time of the period in a case where the distribution start time of the content is designated as a reference “0” are described. Further, although not illustrated, the URLs etc. of MSs contained in each period are also described. By using these items of information, the client apparatus 100 can receive and replay that portion of the content which corresponds to the period.

That is, a period described in the MPD 51 indicates an interval of replay during which the client apparatus 100 can perform a replay. For this reason, the replay control section 41 can decide, on the basis of a period described in the MPD 51, whether or not to prohibit, at the current replay position, replay control that the user has instructed the client apparatus 100 to perform (i.e. whether or not to execute the replay control as instructed).

For example, since the MPD 51 of FIG. 4 does not contain the period id=3 and its subsequent periods, the replay control section 41 decides not to execute fast forward replay control in the period id=2. That is, the period id=2 is designated as an interval of prohibition of fast-forward. Moreover, when a fast-forward operation has been performed during a replay of the period id=2, the replay control section 41 does not perform fast-forward control, but the notification section 43 notifies the user that fast-forward is prohibited.

[Flow of a Process at the Time of a Fast-Forward Operation]

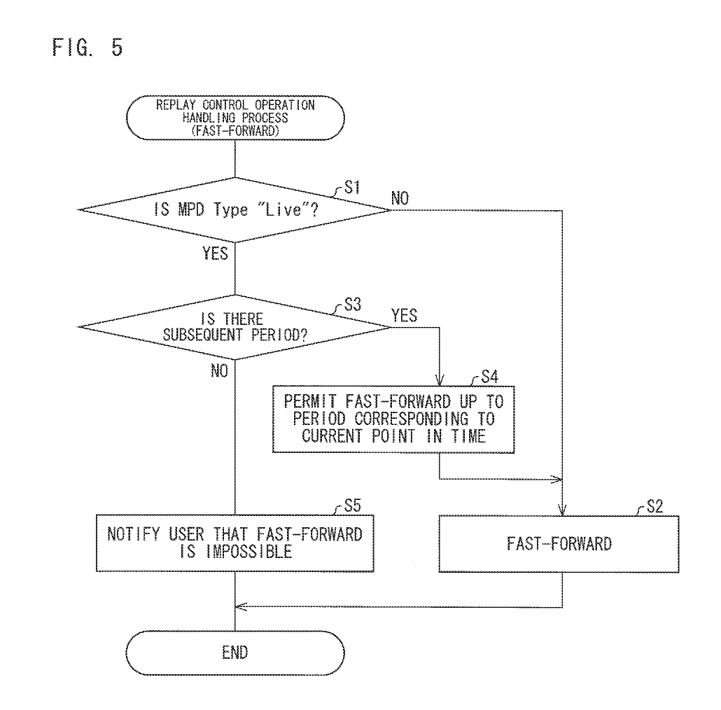

In the following, a replay control operation handling process (replay method) that the client apparatus 100 executes when a fast-forward operation has been performed is described with reference to FIG. 5. FIG. 5 is a flow chart showing an example of a replay control operation handling process that the client apparatus 100 executes when a fast-forward operation has been performed.

A user's fast-forward operation is accepted by the input section 110, and the input section 110 transmits, to the replay control section 41, a control signal that instructs the replay control section 41 to perform the fast-forward operation. Then, upon receiving the control signal, the replay control section 41 decides, with reference to the MPD 51 stored in the storage section 150, whether or not the attribute value of “type” is “Live” (Si).

It should be noted that in a case where the client apparatus 100 is also compatible with content replay without the use of MPD (i.e. a replay of content stored in advance in the client apparatus 100), the step of confirming the presence or absence of the MPD 51 may be executed prior to S1. In this case, if there is no MPD 51 (if no MPD 51 is needed for the content to be replayed), replay control of the content is performed as usual.

In a case where the replay control section 41 has decided, in S1, that the attribute value of “type” is not “Live” (NO in S1), the replay control section 41 performs fast-forward (S2). Specifically, the replay control section 41 controls the replay section 40 and the communication control section 42 to increase the speed at which the content is replayed, thus ending the replay control operation handling process.

On the other hand, in a case where the replay control section 41 has decided, in S1, that the attribute value of “type” is “Live” (YES in S1), the replay control section 41 decides whether or not a period subsequent to the currently replayed period (i.e. a period whose id attribute value is larger by 1 than the id attribute value of the currently replayed period) is described in the MPD 51 (S3). Since whether or not to execute fast-forward replay control is decided in accordance with a result of this decision, S3 can be said to be a replay control step of deciding whether or not to execute replay control.

In a case where the replay control section 41 has decided, in S3, that the subsequent period (i.e. the next period to be replayed after the period being replayed) is described (YES in S3), the replay control section 41 permits fast-forward to be performed up to a period corresponding to the current point in time (S4). That is, the replay control section 41 controls the replay section 40 and the communication control section 42 to perform fast-forward up to the period corresponding to the current point in time. This causes fast-forward to be performed up to the period corresponding to the current point in time (S2), whereby the replay control operation handling process ends.

The term “period corresponding to the current point in time” in S4 refers to a temporally most advanced period that can be replayed at the current point in time. For example, in the example shown in FIG. 3, the period P5 correspond to such a period. Therefore, in the case of fast-forward starting from the period P3 in the example shown in FIG. 3, the fast-forward is performed up into the period P5, and once in the period P5, the replay returns to the normal speed.

On the other hand, in a case where the replay control section 41 has decided that there is no subsequent period described (NO in S3), the replay control section 41 instructs the notification section 43 to notify the user that fast-forward is impossible (S5, notification step), thus ending the replay control operation handling process.

Although the foregoing description has been given by taking fast-forward as an example, the same process can be applied to a case where a forward (i.e., the direction in which the replay of the content will proceed) time-shifting operation has been performed. However, in the case of a time-shifting operation across a plurality of periods, it is necessary to determine, in S3, the presence or absence not of a subsequent period but of a period for which the time-shifting is destined.

[Flow of a Process at the Time of a Fast-Rewind Operation]

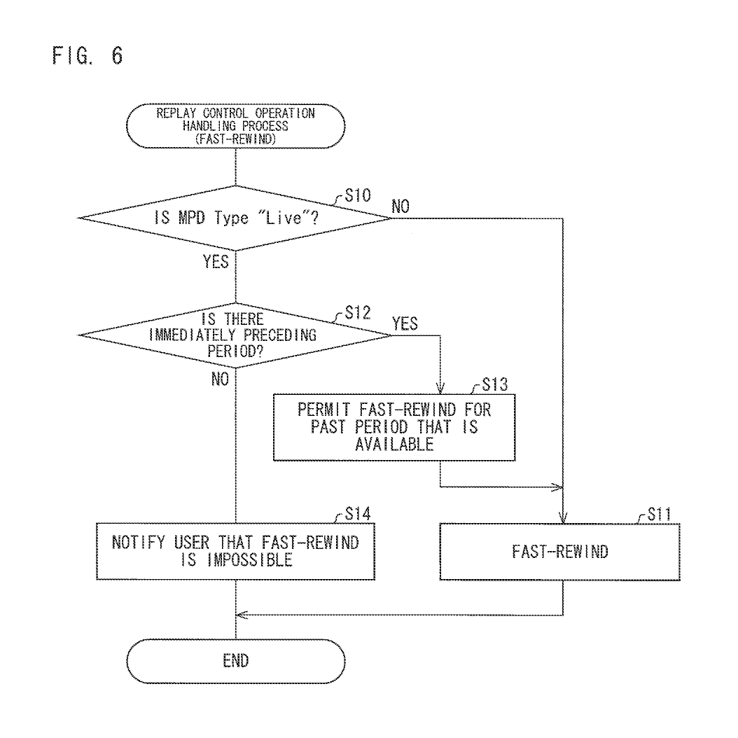

Next, a replay control operation handling process (replay method) that the client apparatus 100 executes when a fast-rewind operation has been performed is described with reference to FIG. 6. FIG. 6 is a flow chart showing an example of a replay control operation handling process that the client apparatus 100 executes when a fast-rewind operation has been performed.

A user's fast-rewind operation is accepted by the input section 110, and the input section 110 transmits, to the replay control section 41, a control signal that instructs the replay control section 41 to perform the fast-rewind operation. Then, upon receiving the control signal, the replay control section 41 decides, with reference to the MPD 51 stored in the storage section 150, whether or not the attribute value of “type” is “Live” (S10).

In a case where the replay control section 41 has decided, in S10, that the attribute value of “type” is not “Live” (NO in S10), the replay control section 41 controls the replay section 40 and the communication control section 42 to perform fast-forward (S11), thus ending the replay control operation handling process.

On the other hand, in a case where the replay control section 41 has decided, in S10, that the attribute value of “type” is “Live” (YES in S10), the replay control section 41 decides whether or not a period immediately preceding the currently replayed period (i.e. a period whose id attribute value is smaller by 1 than the id attribute value of the currently replayed period) is described in the MPD 51 (S12). Since whether or not to execute fast-rewind replay control is decided in accordance with a result of this decision, S12 can be said to be a replay control step of deciding whether or not to execute replay control.

In a case where the replay control section 41 has decided, in S12, that the immediately preceding period (i.e. the period to be replayed immediately before the period being replayed) is described (YES in S12), the replay control section 41 permits fast-rewind to be performed for a past period that is available (S13). That is, the replay control section 41 controls the replay section 40 and the communication control section 42 to perform fast-rewind back to a period timed to be replayed earliest (i.e. a period located nearest to the head of the content) among those periods described in the MPD 51. This causes fast-rewind to be performed back to the designated period (S11), whereby the replay control operation handling process ends.

For example, in the example shown in FIG. 3, the period timed to be replayed earliest among those periods described in the MPD 51 is the period P3. Therefore, the fast-forward is performed back into the period P3, and once in the period P3, the replay returns to the normal speed (forward replay at the normal speed).

On the other hand, in a case where the replay control section 41 has decided that there is no immediately preceding period described (NO in S12), the replay control section 41 instructs the notification section 43 to notify the user that fast-rewind is impossible (S14, notification step), thus ending the replay control operation handling process. As in the case of fast-forward, the user may be notified in any manner that allows the user to recognize that fast-rewind is impossible.

Although the foregoing description has been given by taking fast-rewind as an example, the same process can be applied to a case where a backward (i.e., a direction opposite to the direction in which the replay of the content will proceed) time-shifting operation has been performed. However, in the case of a time-shifting operation across a plurality of periods, it is necessary to determine, in S12, the presence or absence not of an immediately preceding period but of a period for which the time-shifting is destined.

### Embodiment 2

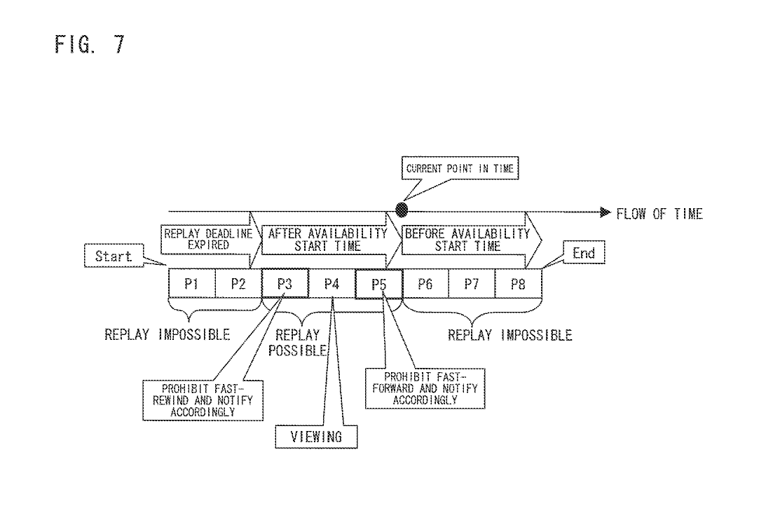

Next, a distribution system of Embodiment 2 of the present invention is described with reference to FIGS. 7 through 10. The present embodiment is different from the foregoing embodiment in terms of the specific content of an MPD-based decision as to whether or not to permit replay control, but is identical in system configuration and apparatus configuration to the foregoing embodiment. That is, the distribution system of the present embodiment, too, is of a configuration shown in FIGS. 1 and 2. The present embodiment, too, is described with reference to the same reference signs as those shown in FIGS. 1 and 2.

[Interval of Replay During which Replay Control is Prohibited]

First, an interval of prohibition of the present embodiment is described with reference to FIG. 7. FIG. 7 is a diagram explaining an interval of replay during which a particular replay control is prohibited. In the example shown in FIG. 7, as in the example shown in FIG. 3, the video content to be replayed consists of eight periods, namely periods P1 to P8.

In the example shown in FIG. 7, all of the eight periods P1 to P8 are described in the MPD. Those periods preceding the current point in time are prohibited from being replayed, as they are earlier than an availability start time. Further, the period P2 and its preceding period cannot be replayed, as the replay deadline for these periods has expired. That is, in the example shown in FIG. 7, as in the example shown in FIG. 3, the periods P3 to P5 can be replayed. Moreover, the client apparatus 100 is replaying the period P4, which the user is viewing.

In this embodiment, too, in the client apparatus 100, fast-forward is prohibited in a situation where the next period cannot be replayed. That is, the period P5 is designated as an interval of prohibition of fast-forward replay control. Further, the period P3, whose immediately preceding period cannot be acquired, is designated as an interval of prohibition of fast-rewind replay control. Moreover, when a replay control operation that is prohibited has been performed in such an interval of prohibition, the user is notified that the operation is prohibited.

It should be noted that in a case where a period for which a replay deadline has expired can be acquired from another server, whether or not to permit replay control may be decided with the period deemed to be acquirable. In this case, it is only necessary to describe, in the MPD, information for acquiring the period from another server.

[MPD-Based Decision as to Whether or Not to Permit Replay Control]

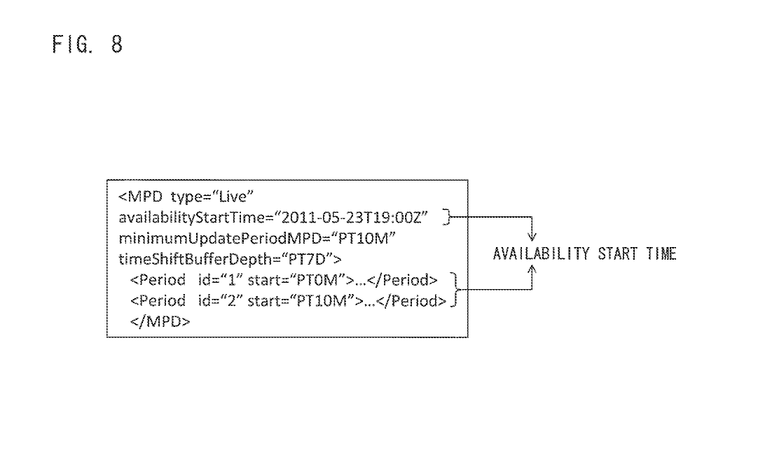

In the present embodiment, too, the replay control section 41 of the client apparatus 100 decides, with reference to the MPD 51 stored in the storage section 150, whether or not to permit replay control. This method of decision is described with reference to FIG. 8. FIG. 8 is a diagram showing how the client apparatus 100 decides, on the basis of the MPD 51, whether or not to permit replay control. The MPD 51 illustrated is the same as that shown in FIG. 4.

As illustrated, the availability start time is determined on the basis of the attribute value of the attribute “availabilityStartTime” of the MPD 51 and the attribute value of “start” of each period. That is, these attributes are time specifying information for specifying, for each period, a point in time where the period becomes replayable.

“availabilityStartTime” indicates a point in time where content corresponding to the MPD 51 becomes replayable (i.e. a point in time where a streaming replay is started). In the example illustrated, the attribute value of “availabilityStartTime” is described as “2011-05-23T19:00Z”. This specifies that the point in time where the content becomes replayable is 19:00, May 23, 2011.

Further, as already described, the attribute value of “start” of each period indicates a timing at which the period becomes replayable, as counted from a point in time (zero) where the content becomes replayable. That is, the period becomes replayable at a point in time that is calculated by adding the attribute value of “start” to the attribute value of “availabilityStartTime”.

See FIG. 8 for a specific example. Since the attribute value of “start” of the period id=1 is zero, the period id=1 becomes replayable at 19:00, May 23, 2011, i.e. at the same time as “availabilityStartTime”. Meanwhile, since the attribute value of “start” of the period id=2 is 10M, the period id=2 becomes replayable at 19:10, May 23, 2011, i.e. 10M after “availabilityStartTime”.

By thus using the attribute values of “availabilityStartTime” and “start”, it is possible to discriminate between a period that is replayable at the current point in time and a period that cannot be replayed at the current point in time. This allows the replay control section 41 to decide, on the basis of these items of information described in the MPD 51, whether or not to permit replay control.

See an example where the MPD 51 of FIG. 8 is used. When the current point in time is 19:05, May 23, 2011, the period id=2 is non-replayable because the availability start time has yet to come, while the period id=1 is replayable. Therefore, in a case where fast-forward replay control in the period id=1 is performed at a time like this, the replay control section 41 decides not to execute the replay control. That is, the period id=1 is designated as an interval of prohibition of fast-forward. Moreover, when a fast-forward operation has been performed while the period id=1 is being replayed, the replay control section 41 does not perform fast-forward control but causes the notification section 43 to notify the user that fast-forward is prohibited.

It should be noted that in such a case where an interval of prohibition is designated on the basis of the availability start time, all of the periods may be contained in advance in the MPD 51. Further, although not shown in the example illustrated, by describing, in the MPD 51, deadline information for specifying a replay deadline for a period, it is possible to decide, on the basis of the current point in time and the deadline information, whether or not to permit replay control for a reverse replay such as fast-rewind.

[Flow of a Process at the Time of a Fast-Forward Operation]

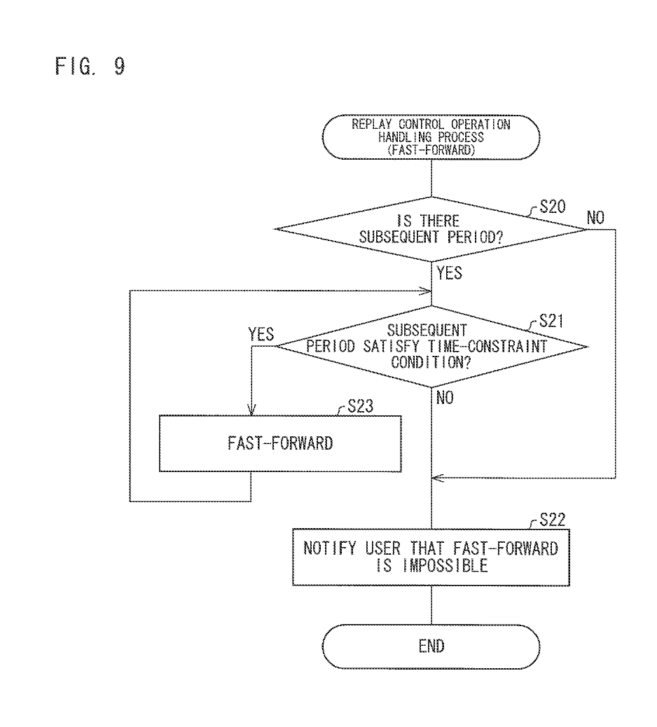

Next, a replay control operation handling process (replay method) that, in the present embodiment, the client apparatus 100 executes when a fast-forward operation has been performed is described with reference to FIG. 9. FIG. 9 is a flow chart showing an example of a replay control operation handling process that the client apparatus 100 executes when a fast-forward operation has been performed.

A user's fast-forward operation is accepted by the input section 110, and the input section 110 transmits, to the replay control section 41, a control signal that instructs the replay control section 41 to perform the fast-forward operation. Then, upon receiving the control signal, the replay control section 41 decide, with reference to the MPD 51 stored in the storage section 150, whether or not a period subsequent to the currently replayed period is described (S20).

In a case where the replay control section 41 has decided, in S20, that the subsequent period is described (YES in S20), the replay control section 41 proceeds to S21. On the other hand, in a case where the replay control section 41 has decided that there is no subsequent period described (NO in S20), the replay control section 41 instructs the notification section 43 to notify the user that fast-forward is impossible (S22, notification step), thus ending the replay control operation handling process.

In S21, the replay control section 41 decides whether or not the subsequent period satisfies a time-constraint condition, i.e. whether or not the subsequent period is a period subsequent to the availability start time. Specifically, the replay control section 41 reads out the attribute value of “availabilityStartTime” and the attribute value of “start” of the subsequent period from the MPD 51. Then, the replay control section 41 makes a comparison between a point in time calculated by adding the attribute value of “start” to the attribute value of “availabilityStartTime” and the current point in time. If the point in time thus calculated coincides with or precedes the current point in time, the replay control section 41 decides that the subsequent period satisfies the time-constraint condition. On the other hand, if the point in time thus calculated follows the current point in time, the replay control section 41 decides that the subsequent period does not satisfy the time-constraint condition. Since whether or not to execute fast-forward replay control is decided in accordance with a result of this decision, S21 can be said to be a replay control step of deciding whether or not to execute replay control.

In a case where the replay control section 41 has decided, in S21, that the subsequent period does not satisfy the time-constraint condition (NO in S21), the replay control section 41 instructs the notification section 43 to notify the user that fast-forward is impossible (S22, notification step), thus ending the replay control operation handling process. On the other hand, in a case where the replay control section 41 has decided that the subsequent period satisfies the time-constraint condition (YES in S21), the replay control section 41 controls the replay section 40 and the communication control section 42 to perform fast-forward (S23).

Further, during the fast-forward, the replay control section 41 decides whether or not a period subsequent to a period to which the current replay position belongs satisfies the time-constraint condition (S21). In a case where the replay control section 41 has decided, in S21, that the subsequent period satisfies the time-constraint condition (YES in S21), the fast-forward is continued (S23).

On the other hand, in a case where the replay control section 41 has decided that the subsequent period does not satisfy the time-constraint condition (NO in S21), the replay control section 41 controls the replay section 40 and the communication control section 42 to stop the fast-forward. Further, the replay control section 41 instructs the notification section 43 to notify the user that fast-forward is impossible (S22, notification step), thus ending the replay control operation handing process.

Although the foregoing description has been given by taking fast-forward as an example, the same process can be applied to a case where a forward (i.e., the direction in which the replay of the content will proceed) time-shifting operation has been performed. However, in the case of a time-shifting operation across a plurality of periods, it is necessary to determine the presence or absence not of a subsequent period but of a period for which the time-shifting is destined and decide whether or not the period satisfies the time-constraint condition. [Flow of a Process at the Time of a Fast-Rewind Operation]

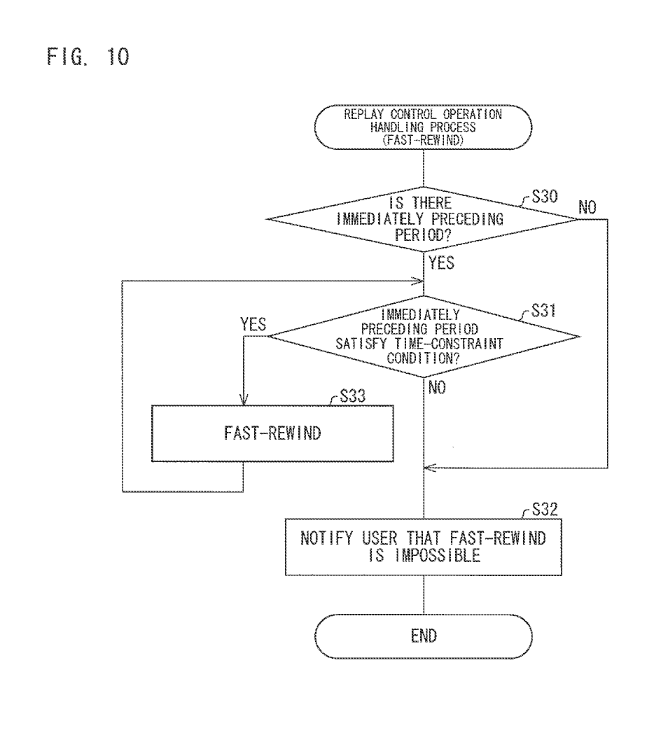

Next, a replay control operation handling process (replay method) that, in the present embodiment, the client apparatus 100 executes when a fast-rewind operation has been performed is described with reference to FIG. 10. FIG. 10 is a flow chart showing an example of a replay control operation handling process that the client apparatus 100 executes when a fast-rewind operation has been performed.

A user's fast-rewind operation is accepted by the input section 110, and the input section 110 transmits, to the replay control section 41, a control signal that instructs the replay control section 41 to perform the fast-rewind operation. Then, upon receiving the control signal, the replay control section 41 decides, with reference to the MPD 51 stored in the storage section 150, whether or not a period immediately preceding the currently replayed period is described (S30).

In a case where the replay control section 41 has decided, in S30, that the immediately preceding period is described (YES in S30), the replay control section 41 proceeds to S31. On the other hand, in a case where the replay control section 41 has decided that there is no immediately preceding period described (NO in S30), the replay control section 41 instructs the notification section 43 to notify the user that fast-rewind is impossible (S32, notification step), thus ending the replay control operation handling process.

In S31, the replay control section 41 decides whether or not the immediately preceding period satisfies a time-constraint condition, i.e. whether or not the immediately preceding period is a period for which a replay deadline has expired. Specifically, the replay control section 41 reads out, from the MPD 51, information indicating a replay deadline for the subsequent period. Then, the replay control section 41 makes a comparison between a point in time specified from the information and the current point in time. If the point in time coincides with or follows the current point in time, the replay control section 41 decides that the immediately preceding period satisfies the time-constraint condition. On the other hand, if the point in time is earlier than the current point in time, the replay control section 41 decides that the immediately preceding period does not satisfy the time-constraint condition. Since whether or not to execute fast-rewind replay control is decided in accordance with a result of this decision, S31 can be said to be a replay control step of deciding whether or not to execute replay control.

In a case where the replay control section 41 has decided, in S31 that the immediately preceding period does not satisfy the time-constraint condition (NO in S31), the replay control section 41 instructs the notification section 43 to notify the user that fast-rewind is impossible (S32, notification step), thus ending the replay control operation handling process. On the other hand, in a case where the replay control section 41 has decided that the immediately preceding period does not satisfy the time-constraint condition (YES in S31), the replay control section 41 controls the replay section 40 and the communication control section 42 to perform fast-rewind (S33).

Further, during the fast-rewind, the replay control section 41 decides whether or not a period immediately preceding a period to which the current replay position belongs satisfies the time-constraint condition (S31). In a case where the replay control section 41 has decided, in S31, that the immediately preceding period satisfies the time-constraint condition (YES in 321), the fast-rewind is continued (S33).

On the other hand, in a case where the replay control section 41 has decided that the immediately preceding period does not satisfy the time-constraint condition (NO in S31), the replay control section 41 controls the replay section 40 and the communication control section 42 to stop the fast-rewind. Further, the replay control section 41 instructs the notification section 43 to notify the user that fast-rewind is impossible (S32, notification step), thus ending the replay control operation handing process.

Although the foregoing description has been given by taking fast-rewind as an example, the same process can be applied to a case where a backward (i.e., a direction opposite to the direction in which the replay of the content will proceed) time-shifting operation has been performed. However, in the case of a time-shifting operation across a plurality of periods, it is necessary to determine the presence or absence not of an immediately preceding period but of a period for which the time-shifting is destined and decide whether or not the period satisfies the time-constraint condition.

[Modification]

The present invention is not limited to the description of the embodiments above, but may be altered by a skilled person within the scope of the claims. An embodiment based on a proper combination of technical means disclosed in different embodiments is encompassed in the technical scope of the present invention.

Further, an embodiment that is obtained by combining

Embodiment 1 and Embodiment 2 is encompassed in the technical scope. For example, while Embodiment 1 permits fast-forward up to a period corresponding to the current point in time (S4 of FIG. 5), Embodiment 2 may detect entering into an interval of replay during which fast-forward control is not executed while fast-forward is being performed (S21 to S23 of FIG. 9). Further, in Embodiment 2, as in Embodiment 1, it is possible to decide whether or not the attribute value of “type” is “Live” (S1 of FIG. 5).

[Program Configuration Example]

Blocks of the client apparatus 100 (particularly, the control section 14) may be realized in the form of hardware by a logic circuit (hardware) provided on an integrated circuit (IC chip) or the like or may be realized in the form of software as executed by a CPU (Central Processing Unit).

In the latter case, the client apparatus 100 includes: a CPU that executes instructions of a program realizing the foregoing functions; ROM (Read Only Memory) storing the program; RAM (Random Access Memory) that develops the program; and a storage device (storage medium), such as a memory, storing the program and various kinds of data. The objective of the present invention can also be achieved by mounting to the client apparatus 100 a computer-readable storage medium containing control program code (executable program, intermediate code program, or source program) for the the client apparatus 100, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; a semiconductor memory, such as a mask ROM/EPROM/EEPROM (Registered Trademark)/flash ROM; or a logic circuit such as a PLD (Programmable logic device) or an FPGA (Field Programmable Gate Array).

The client apparatus 100 may be arranged to be connectable to a communications network so that the program code may be delivered over the communications network. The communications network is not limited in any particular manner, provided the program code can be transferred over the communications network. The communications network may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, provided it is a medium via which the program code can be transferred. The transfer medium may be, for example, wired line, such as IEEE 1394, USB, electric power line, cable TV line, telephone line, or ADSL (Asymmetric Digital Subscriber Line) line; or wireless, such as infrared radiation (IrDA, remote control), Bluetooth (Registered Trademark), IEEE 802.11 wireless, HDR (High Data Rate), NFC (Near Field Communication), DLNA (Digital Living Network Alliance), mobile telephone network, satellite line, or terrestrial digital network. The present invention encompasses a carrier wave or data signal transmission in which the program code is embodied electronically. Further, the program code may be made available via a broadcasting path such as a terrestrial digital broadcasting path or a satellite broadcasting path.

[Main Points of the Invention]

As described above, As described above, a replay apparatus of the present invention includes: replay control means for, upon accepting a user's operation that gives a command to execute replay control of the content, making a decision as to whether or not to execute the replay control, the decision being based on which part of the content is a constituent part that is specified by the content acquisition information and that is acquirable at a point in time where the command was accepted; and notification means for, in a case where the replay control means has decided not to execute the replay control, notifying the user that the replay control is prohibited.

Moreover, the replay apparatus is preferably configured such that: during execution of replay control that causes a replay position to shift in a form that is different from a form in which it does in a normal replay, the replay control means makes a decision as to whether or not to discontinue the replay control, the decision being based on which part of the content is a constituent part that is specified by the content acquisition information and that is acquirable at a current point in time; and in a case where the replay control has been discontinued, the notification means notifies the user that the replay control is prohibited.

According to the foregoing configuration, during replay control, a decision as to whether or not to discontinue the replay control is made on the basis of a constituent part of the content that is specified by the content acquisition information and that is acquirable at the current point in time, and in a case where the replay control has been discontinued, the user is notified that the replay control is prohibited.

Therefore, when, during the replay control, the replay position has reached a position where the replay control cannot be continued or where it is not preferable that the replay control be continued, the replay control can be discontinued. Moreover, since the user is notified at this point in time, the user can recognize that the replay control is prohibited.

Further, the replay apparatus is preferably configured such that: the content acquisition information contains content attribute information indicating whether or not the content is live distributed content; and the replay control means makes the decision during a replay of content indicated by the content attribute information to be live distributed content.

According to the foregoing configuration, a decision as to whether to execute (or discontinue) replay control is made during a replay of content indicated by the content attribute information to be live distributed content. Conversely, such a decision is not made during a replay of content indicated by the content attribute information not to be live distributed content.

It should be noted here that acquirable constituent parts of the live distributed content vary depending on time, whereby decisions as to whether or not to execute the replay control also vary depending on time. That is, the live distributed content is content for which it is highly necessary to make a decision, based on the content acquisition information, as to whether or not to execute the replay control. On the other hand, content such as VOD is replayed after all of the constituent parts have been acquired, and as such, is content for which it is not highly necessary to make a decision, based on the content acquisition information, as to whether or not to execute the replay control.

That is, according to the foregoing configuration, a decision as to whether or not to execute the replay control is made exclusively for live content exclusively for live distributed content for which it is highly necessary to make such a decision. This makes it possible to prevent an unwanted decision process to be performed on content for which the replay control is not prohibited.

Further, the replay apparatus is preferably configured such that upon accepting a command to execute replay control that causes a replay position to proceed more quickly than it does in a normal replay, the replay control means makes a decision, based on the content acquisition information, as to whether or not a constituent part that is to be replayed after a constituent part corresponding to a current replay position is acquirable; and if the constituent part is not acquirable, the replay control means decides not to execute the replay control.

According to the foregoing configuration, upon accepting a command to execute replay control (such as fast-forward or a skip replay) that causes a replay position to proceed more quickly than it does in a normal replay, the replay control means makes a decision, based on the content acquisition information, as to whether or not a constituent part that is to be replayed after a constituent part corresponding to a current replay position is acquirable; and if the constituent part is not acquirable, the replay control means decides not to execute the replay control.

This prevents the replay from being discontinued when execution of fast-forward, a skip replay, or the like in a situation where the next constituent part is not acquirable causes the replay position to proceed to the end of the currently replayed constituent part before the next constituent part becomes acquirable. Further, since the user is notified in a case where it has been decided that the replay control is not executed, the user can recognize that the replay control (such as fast-forward) is prohibited.

Further, the replay apparatus is preferably configured such that upon accepting a command to execute replay control that causes a replay position to shift in a direction opposite to a direction in which it does in a normal replay, the replay control means makes a decision, based on the content acquisition information, as to whether or not a constituent part that is to be replayed immediately before a constituent part corresponding to the current replay position is acquirable; and if the constituent part is not acquirable, the replay control means decides not to execute the replay control.

According to the foregoing configuration, upon accepting a command to execute replay control (such as fast-rewind, a skip replay in a direction opposite to a normal replay, or a backward slow replay) that causes a replay position to shift in a direction opposite to a direction in which it does in a normal replay, the replay control means makes a decision, based on the content acquisition information, as to whether or not a constituent part that is to be replayed immediately before a constituent part corresponding to the current replay position is acquirable; and if the constituent part is not acquirable, the replay control means decides not to execute the replay control.

This prevents the replay from being discontinued at the head of the currently replayed constituent part by performing fast-rewind or the like in a situation where the preceding constituent part is not acquirable. Further, since the user is notified in a case where it has been decided that the replay control is not executed, the user can recognize that the replay control (such as fast-rewind) is prohibited.

It should be noted that in a case where the currently replayed constituent part corresponds to the head of the content, it is not unnatural for the replay to be discontinued at the head (i.e. the head of the content). Therefore, in a case where the currently replayed constituent part corresponds to the head of the content, replay control such as fast-rewind may be executed.

Further, the replay apparatus is preferably configured such that: the content acquisition information contains time specifying information for specifying, for each of the constituent parts of the content, a point in time where the constituent part becomes replayable; upon accepting a command to execute replay control that causes a replay position to proceed more quickly than it does in a normal replay, the replay control means decides not to execute the replay control, if a point in time specified by the time specifying information for a constituent part that is to be replayed after a constituent part corresponding to a current replay position is later than a current point in time.

According to the foregoing configuration, upon accepting a command to execute replay control (such as fast-forward or a skip replay) that causes a replay position to proceed more quickly than it does in a normal replay, the replay control means decides, on the basis of the time specifying information contained in the content acquisition information, not to execute the replay control, if a point in time specified for a constituent part that is to be replayed after a constituent part corresponding to a current replay position is later than a current point in time. That is, unless, at the point in time where a command to execute replay control was accepted, the next constituent part reaches a point in time where it is replayable, the reproduction process is not performed.

This prevents the replay from being discontinued when execution of fast-forward, a skip replay, or the like before the next constituent part reaches a point in time where it is acquirable causes the replay position to proceed to the end of the currently replayed constituent part before the next constituent part becomes acquirable. Further, since the user is notified in a case where it has been decided that the replay control is not executed, the user can recognize that the replay control (such as fast-forward) is prohibited.

Further, the replay apparatus is preferably configured such that: the content acquisition information contains deadline information for specifying, for each of the constituent parts of the content, a point in time at which a replay deadline for replaying the constituent part expires; upon accepting a command to execute replay control that causes a replay position to shift in a direction opposite to a direction in which it does in a normal replay, the replay control means decides not to execute the replay control, if a point in time specified by the deadline information for a constituent part that is to be replayed immediately before the constituent part corresponding to the current replay position is earlier than the current point in time.

According to the foregoing configuration, upon accepting a command to execute replay control (such as fast-rewind, a skip replay in a direction opposite to a normal replay, or a backward slow replay) that causes a replay position to shift in a direction opposite to a direction in which it does in a normal replay, the replay control means decides not to execute the replay control, if a point in time specified by the deadline information for a constituent part that is to be replayed before the constituent part corresponding to the current replay position is earlier than the current point in time.

This prevents the replay from being discontinued at the head of the currently replayed constituent part by performing fast-rewind or the like in a situation where a replay deadline for replaying the preceding constituent part has expired. Further, since the user is notified in a case where it has been decided that the replay control is not executed, the user can recognize that the replay control (such as fast-rewind) is prohibited.

It should be noted that in a case where the currently replayed constituent part corresponds to the head of the content, it is not unnatural for the replay to be discontinued at the head (i.e. the head of the content). Therefore, in a case where the currently replayed constituent part corresponds to the head of the content, replay control such as fast-rewind may be executed.

The replay apparatus may be realized by a computer. In this case, the present invention encompasses: a control program for the replay apparatus which program causes a computer to operate as the foregoing means of the replay apparatus so that the replay apparatus can be realized by the computer; and a computer-readable storage medium storing the control program therein.

### INDUSTRIAL APPLICABILITY

The present invention is applicable, for example, to an apparatus for replaying content that is distributed in real time, etc.

### REFERENCE SIGNS LIST

100 Client apparatus (replay apparatus)

41 Replay control section (replay control means)

43 Notification section (notification means)

50 Content

51 MPD (content acquisition information)

1. A replay apparatus for, with reference to content acquisition information containing at least information for acquiring constituent parts of content that is distributed by time division, acquiring and replaying the content,
the replay apparatus comprising:
replay control means for, upon accepting a user's operation that gives a command to execute replay control of the content, making a decision as to whether or not to execute the replay control, the decision being based on which part of the content is a constituent part that is specified by the content acquisition information and that is acquirable at a point in time where the command was accepted; and
notification means for, in a case where the replay control means has decided not to execute the replay control, notifying the user that the replay control is prohibited.

2. The replay apparatus as set forth in claim 1, wherein:
during execution of replay control that causes a replay position to shift in a foam that is different from a form in which it does in a normal replay, the replay control means makes a decision as to whether or not to discontinue the replay control, the decision being based on which part of the content is a constituent part that is specified by the content acquisition information and that is acquirable at a current point in time; and
in a case where the replay control has been discontinued, the notification means notifies the user that the replay control is prohibited.

3. The replay apparatus as set forth in claim 1, wherein:
the content acquisition information contains content attribute information indicating whether or not the content is live distributed content; and
the replay control means makes the decision during a replay of content indicated by the content attribute information to be live distributed content.

4. The replay apparatus as set forth in claim 1, wherein upon accepting a command to execute replay control that causes a replay position to proceed more quickly than it does in a normal replay, the replay control means makes a decision, based on the content acquisition information, as to whether or not a constituent part that is to be replayed after a constituent part corresponding to a current replay position is acquirable; and if the constituent part is not acquirable, the replay control means decides not to execute the replay control.

5. The replay apparatus as set forth in claim 1, wherein upon accepting a command to execute replay control that causes a replay position to shift in a direction opposite to a direction in which it does in a normal replay, the replay control means makes a decision, based on the content acquisition information, as to whether or not a constituent part that is to be replayed immediately before a constituent part corresponding to the current replay position is acquirable; and if the constituent part is not acquirable, the replay control means decides not to execute the replay control.

6. The replay apparatus as set forth claim 1, wherein:
the content acquisition information contains time specifying information for specifying, for each of the constituent parts of the content, a point in time where the constituent part becomes replayable;
upon accepting a command to execute replay control that causes a replay position to proceed more quickly than it does in a normal replay, the replay control means decides not to execute the replay control, if a point in time specified by the time specifying information for a constituent part that is to be replayed after a constituent part corresponding to a current replay position is later than a current point in time.

7. The replay apparatus as set forth in claim 1, wherein:
the content acquisition information contains deadline information for specifying, for each of the constituent parts of the content, a point in time at which a replay deadline for replaying the constituent part expires;
upon accepting a command to execute replay control that causes a replay position to shift in a direction opposite to a direction in which it does in a normal replay, the replay control means decides not to execute the replay control, if a point in time specified by the deadline information for a constituent part that is to be replayed immediately before the constituent part corresponding to the current replay position is earlier than the current point in time.

8. A replay apparatus for, with reference to content acquisition information containing (i) information for acquiring constituent parts of content that is distributed by time division and (ii) content attribute information indicating whether or not the content is live distributed content, acquiring and replaying the content,
the replay apparatus comprising:
replay control means for (1) judging on a basis of the content acquisition information whether or not content being replayed is live distributed content, for (2), if having judged that the content being replayed is live distributed content, doing an action of, upon accepting a user's operation that gives a command to execute replay control that causes a replay position to shift in a form that is different from a form in which it does in a normal replay, makes a decision as to whether or not to execute the replay control, the decision being based on which part of the content is a constituent part that is specified by the content acquisition information and that is acquirable at a point in time where the command was accepted, and for (3), if having decided to execute the replay control, doing an action of, during execution of the replay control, making a decision as to whether or not to discontinue the replay control, the decision being based on which part of the content is a constituent part that is specified by the content acquisition information and that is acquirable at a current point in time; and
notification means for, in a case where the replay control means has decided not to execute the replay control and in a case where the replay control means has decided to discontinue the replay control, notifying the user that the replay control is prohibited.

9. A replay method by a replay apparatus for, with reference to content acquisition information containing at least information for acquiring constituent parts of content that is distributed by time division, acquiring and replaying the content,
the replay method comprising:
a replay control step of, upon accepting a user's operation that gives a command to execute replay control of the content, making a decision as to whether or not to execute the replay control, the decision being based on which part of the content is a constituent part that is specified by the content acquisition information and that is acquirable at a point in time where the command was accepted; and
a notification step of, in a case where it has been decided in the replay control step that the replay control is not executed, notifying the user that the replay control is prohibited.

10. (canceled)

11. A non-transitory computer-readable storage medium containing a control program for operating a replay apparatus as set forth in claim 1, the control program causing a computer to function as the replay control means and the notification means.
